(19) United States
(12) Patent Application Publication
(10) Pub. No.: US 2015/0175476 A1
(43) Pub. Date: Jun. 25, 2015

(54) Method for Forming a Smooth Glaze-Like Coating on a Substrate Made of a Ceramic Matrix Composite Material Containing Sic, and Part Made of a Ceramic Material Composite Provided with Such a Coating

(71) Applicants: Pascal Diss, Le Haillan (FR); Lionel Montagne, Laventie (FR); Sofia Perez-Villar, Badzurzach (CH)

(72) Inventors: Pascal Diss, Le Haillan (FR); Lionel Montagne, Laventie (FR); Sofia Perez-Villar, Badzurzach (CH)

(21) Appl. No.: 14/343,110

(22) PCT Filed: Aug. 31, 2012
(86) PCT No.: PCT/FR2012/051964

§ 371 Date: Nov. 7, 2014

(30) Foreign Application Priority Data
Sep. 6, 2011 (FR) 1157890

(51) Int. Cl. C03C 8/04; C03C 8/02; C04B 35/565; C03C 3/091; C03C 3/093; B05D 7/00; C03C 8/16

(52) U.S. Cl. CPC C03C 8/04; B05D 7/50; C03C 8/02; C03C 8/16; C03C 3/091; C03C 3/093; C04B 35/565; C03C 2205/00

(57) ABSTRACT

The method includes depositing on the entire surface of a substrate a refractory cement paste formed by a powder mainly constituted by silica and alumina and mixed with a liquid. The method includes filling the cement paste in hollow portions in a relief of the surface; performing a heat treatment to harden the cement paste after it has set to obtain a first coating layer of refractory cement; and depositing a slip on the first layer, and formed of a glass frit in suspension in a liquid. The method includes performing a heat treatment for glazing by softening and spreading the glass in order to obtain a second coating layer forming a glaze covering the first layer. The composition of the glass frit is selected to form a glass having a glazing temperature lower than 1100° C. and a glass transition temperature lower than 750° C.

### BACKGROUND OF THE INVENTION

The invention relates to forming a coating having a smooth outside surface of glazed appearance on a substrate of ceramic matrix composite (CMC) material containing silicon carbide (SiC).

The invention is applicable in particular to parts used in turbine engines, and more particularly to parts that are exposed in service to high temperatures, such as for example: turbine blades or vanes or afterbody elements of aviation turbine engines.

The search for greater efficiency and smaller polluting emissions has led to ever higher operating temperatures being envisaged for turbine engines. The use of CMC materials instead of metal alloys has thus been recommended in order to make hot parts of turbine engines. CMC materials are remarkable for their mechanical properties, that make them suitable for forming structural parts, and for their ability to conserve these properties at high temperatures. In addition, compared with metal alloys, CMC materials present lower density and thus achieve savings in weight.

CMC materials are constituted by fiber reinforcement made of refractory fibers (carbon fibers or ceramic fibers) densified by a ceramic matrix. The CMC materials referred to herein are those having a ceramic matrix containing SiC, and in particular those in which the ceramic matrix is made mainly of SiC. Typical examples of such CMC materials are C—SiC materials (reinforcement made of carbon fibers and matrix made of SiC), SiC—SiC materials, and materials in which the matrix is mixed or sequenced, e.g. materials having a mixed C/SiC matrix or materials having a matrix made up of phases of SiC alternating with phases of pyrolytic carbon (PyC) or of boron carbide (B₄C), or of a ternary Si—B—C system.

Nevertheless, CMC materials present a surface appearance that is undulating and relatively rough, and that can be found to be incompatible with the aerodynamic performance required of turbine engine parts. The undulation in the surface is due to the generally-woven fiber reinforcement, whereas the roughness is associated with the way in which the matrix is obtained, the matrix generally being formed by chemical vapor infiltration (CVI).

Proposals have thus been made to provide such CMC parts with a smoothing coating to give the parts a surface appearance that is smooth. Document WO2010/112768 describes forming such a smoothing coating in the form of a glass that is essentially constituted by silica (SiO₂), alumina (Al₂O₃), baryte (BaO), and lime (CaO), with a melting temperature greater than or equal to 1300° C.

Forming a protective vitreous coating on a material containing SiC is described in other documents.

Thus, an article by M. Ferraris et al., “Glass coating for SiCf/SiC composites for high-temperature application”, Acta Mater, 48 (2000), pp. 4721-4724, describes forming a coating of a glass of essentially borosilicate type (70.4% SiO₂, 2.1% Al₂O₃, 17.5% B₂O₃, 10% BaO, percentages by weight) on an SiC/SiC composite substrate. In order to avoid bubbles being present in the vitreous coating, the temperature at which the molten glass is glazed on the substrate is raised up to about 1300° C., at which temperature the viscosity of the glass is sufficiently low to facilitate degassing.

An article by F. Qian-Gang et al., “Oxidation protective glass coating for SiC coated carbon/carbon composites for application at 1773K”, Mat. Lett. 60 (2006), pp. 431-434, studies an anti-oxidation protective coating made of a glass of essentially borosilicate type (72%-82% SiO₂, 2%-5% Al₂O₃, 8%-15% B₂O₃, 1%-3% Li₂O, 2%-5% Y₂O₃, percentages by weight). Scanning electron microscope images show a coating surface with holes.

The article by Cheng et al., “Effect of glass sealing on the oxidation behavior of three-dimensional C/SiC composites in air”, Carbon 39 (2001), pp. 1127-1133, describes the use of a borosilicate glass (55 mol %-60 mol % SiO₂ and 40 mol %-45 mol % B₂O₃) for forming a self-healing protective coating on a C—SiC composite. The self-healing temperature lies in the range 700° C. to 900° C., i.e. the temperature at which the softening of the glass enables cracks present in the coating to be filled in.

There exists a need for a method that makes it possible to form a coating on a CMC material containing SiC, which coating presents a surface that is smooth, and advantageously of glazed appearance, being free from defects such as the presence of bubbles or holes. In addition to the above-mentioned thermodynamic properties, such a coating presents the advantage of making it easy to detect even minimal amounts of damage resulting from impacts.

### OBJECT AND SUMMARY OF THE INVENTION

The invention seeks to provide such a method and for this purpose it proposes a method of forming a coating having a smooth outside surface of glazed appearance on a substrate of ceramic matrix composite material containing silicon carbide, the method comprising:

depositing a refractory cement paste on a surface of the substrate, the paste being formed by a powder mainly constituted by silica and alumina and mixed with a liquid, the cement paste filling in the hollow portions in relief of the surface in order to reduce its irregularities and covering the entire surface of the substrate;

performing heat treatment to harden the cement after it has set so as to obtain a first coating layer of refractory cement;

depositing a slip on the first coating layer, the slip being formed of a glass frit in suspension in a liquid, the glass frit being mainly constituted by a powder of silica, boron oxide, alumina, and at least one alkali metal oxide; and

performing heat treatment for glazing by softening and spreading the glass in order to obtain a second coating layer forming a glaze covering the first coating layer;

the composition of the glass frit being selected to form a glass having a glazing temperature lower than 1100° C. and a glass transition temperature lower than 750° C.

Such a method is remarkable because of the following points:

the first layer of refractory cement constitutes a reaction barrier between the glass and the SiC of the substrate. This avoids any chemical reaction between the glass and the SiC at the glazing temperature of the glass, where such a reaction gives off gas and constitutes the source of the defects (bubbles, holes) that are observed in the prior art;

selecting a glass composition that makes it possible for it to be glazed at a temperature lower than 1100° C. avoids raising the CMC material to a temperature at which the mechanical properties of the fibers forming the fiber reinforcement might be affected; and choosing a composition for the glass that has a glass transition temperature lower than 750° C. makes it possible to confer a self-healing ability on the coating as from that temperature.

Advantageously, a coloring agent is added to the slip containing the glass frit. In addition to cosmetic type considerations, depending on its nature the addition of such a coloring agent may confer particular advantages:

facilitating the detection of damage merely by visual examination, even when the damage is minimal, which damage may be due in particular to an impact; and

imparting properties of being discreet, in particular by infrared signature attenuation.

According to a feature of the method, the liquid of the cement paste is selected from: a solution of sodium silicate; a solution of phosphoric acid; and a solution of aluminum monophosphate (Al(H₂PO₄)₃).

According to another feature of the method, a first coating layer of refractory cement is formed having a minimum thickness of not less than 60 micrometers (μm).

Advantageously, the glass frit is constituted by powder having a grain size of less than 40 μm.

In a particular implementation, the composition of the glass frit, in molar percentages, is as follows:

55% to 65% SiO₂

10% to 25% B₂O₃

7% to 15% Al₂O₃

1% to 12% of at least one alkali metal oxide

1% to 20% of at least one oxide selected from ZrO₂, TiO₂, V₂O₅, ZnO, CaO, MgO, and BaO.

Advantageously, the second coating layer forming a glaze has thickness of not less than 100 μm.

In another of its aspects, the invention provides a part having a substrate of CMC containing SiC and provided with a coating of the kind that can be obtained with the above method.

Such a part is characterized in that the coating is formed:

of a first coating layer in contact with the surface of the substrate, the first coating layer being made of a refractory cement essentially constituted of silica and of alumina and filling in the hollow portions in relief of the surface in order to reduce its irregularity; and

a second coating layer forming a glaze of glass constituted mainly of oxides of silicon, of boron, of aluminum, and of at least one alkali metal, the glass having a melting temperature lower than 1100° C. and a glass transition temperature lower than 750° C.

Advantageously, the glaze also contains a coloring agent.

Advantageously, the first coating layer of refractory cement has a minimum thickness of not less than 60 μm.

Advantageously, the second coating layer forming a glaze has a thickness of not less than 100 μm.

In a particular embodiment, the composition of the glass of the glaze in molar percentages is as follows:

55% to 65% SiO₂

10% to 25% B₂O₃

7% to 15% Al₂O₃

1% to 12% of at least one alkali metal oxide

1% to 20% of at least one oxide selected from ZrO₂, TiO₂, V₂O₅, ZnO, CaO, MgO, and BaO.

### BRIEF DESCRIPTION OF THE DRAWINGS

The invention can be better understood on reading the following description given by way of non-limiting indication. Reference is made to the accompanying drawings, in which:

FIG. 1 is a highly diagrammatic view showing the principle of making a coating on a CMC part containing SiC in accordance with the invention;

FIG. 2 shows successive steps in an implementation of a method of the invention; and

FIGS. 3 to 5 are photographs showing the appearance of the coating obtained in various embodiments of the invention.

### DETAILED DESCRIPTION OF EMBODIMENTS

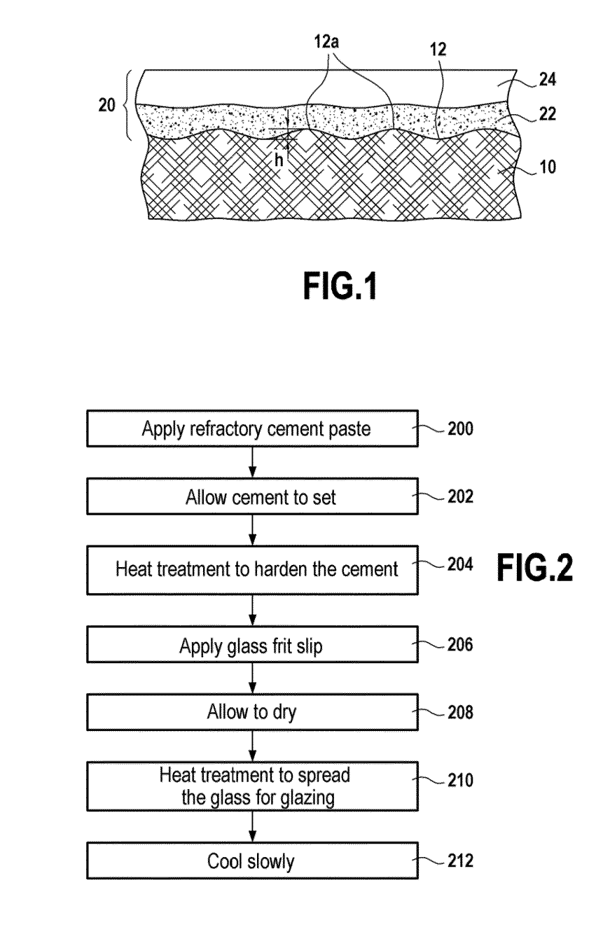

FIG. 1 is a highly diagrammatic section view of a substrate 10 provided on a surface 12 with a coating 20.

The substrate 10 is made of CMC comprising fiber reinforcement densified by a matrix formed at least in part of SiC. The fibers of the reinforcement may be carbon fibers or ceramic fibers. Ceramic fibers may be made of SiC or of oxide, e.g. of alumina. The matrix may be an SiC matrix or a mixed C—SiC matrix, or a sequenced matrix comprising phases of SiC alternating with phases of PyC, B₄C, or Si—B—C. There are well-known methods for fabricating such CMC materials having a matrix formed at least in part out of SiC. In order to fabricate a part of given shape, a fiber preform of a shape corresponding to the shape of the part is made and then the preform is densified by CVI or by a liquid technique, i.e. by one or more cycles comprising impregnation with a liquid composition containing a ceramic precursor polymer, followed by curing and pyrolysis of the precursor. Reference may be made in particular to the following documents: U.S. Pat. No. 5,738,908, U.S. Pat. No. 5,079,039, U.S. Pat. No. 5,246,736, and U.S. Pat. No. 5,965,266.

The fiber preform constituting the reinforcement of the CMC may be obtained using various textile methods, in particular by draping woven fiber plies or by three-dimensional or multilayer weaving. The presence of yarns gives rise to undulations 12a in the surface 12 of the substrate 10, with these undulations typically having a height h of a few hundreds of micrometers. In addition, the substrate presents surface roughness due to the residual porosity of the matrix, whatever the way in which it was obtained, with this roughness presenting a value (in terms of surface level variation) of a few micrometers, commonly 5 μm to 10 μm.

The coating 20 comprises a first coating layer 22 of refractory cement deposited directly on the surface 12 of the substrate 10, and a second coating layer 24 of glass forming a glaze and defining the outside surface of the coating 20. In the example shown, the glaze 24 is deposited directly on the first layer 22, however it is also possible to introduce intermediate layers for the purpose of matching expansion coefficients.

The first layer 22 serves to attenuate the irregularities of the surface 12 of the substrate 10 by at least partially filling in the recesses formed by the undulations 12a and the roughness of the surface 12. The first layer 22 also has a reaction barrier function to avoid chemical reaction between the glass of the glaze 24 and the SiC of the substrate 10. Without the presence of the first layer 22, such a reaction could occur, in particular at the high temperatures needed for glazing the glass of the glaze 24, with gaseous species being given off that might lead to bubbles being included in the glaze 24 or to holes being formed therethrough. The first layer 22 completely covers the surface 12 of the substrate and its minimum thickness is preferably not less than 60 μm, typically lying in the range 100 μm to 300 μm.

The function of the glaze 24 is to form a smooth outside surface of glossy appearance. The glaze 24 also contributes to additional attenuation of surface irregularities, in particular roughness. The thickness of the glaze is preferably greater than 100 μm, typically lying in the range 100 μm to 400 μm. Thickness that is too small may be insufficient for effectively filling in the residual roughness, while thickness that is too great may encourage cracking to form.

The coating 20 may be obtained as follows (FIG. 2).

A first step 200 consists in applying a refractory cement paste on the surface 12 of the substrate 10. The cement paste is obtained by mixing powder and a liquid. The powder is advantageously made up for the most part of silica SiO₂ and of alumina Al₂O₃, the composition of the powder preferably being as follows (in molar percentages);

75% to 90% SiO₂

10% to 25% Al₂O₃

By way of example, the liquid is a solution of sodium silicate with an SiO₂/NaO₂ molar ratio preferably lying in the range 1 to 2. Other solutions may be used, e.g. a solution of phosphoric acid or of aluminum monophosphate (Al(H₂PO₄)₃).

The cement paste is prepared by mixing the liquid vehicle and the powder at a liquid/powder weight ratio lying for example in the range 1 to 2.

It is possible to add organic type additives having a plasticizing or superplasticizing nature in order to make the cement paste more fluid, e.g. melamines or sulfonated salts of naphthalene and formaldehyde polycondensates.

The cement paste is applied on the surface 12 by any known conventional means, e.g. using a spatula, a brush, or a spray gun.

Once the cement has set after a few hours at ambient temperature in the open air (step 202), heat temperature (step 204) is performed to harden the cement. By way of example, the heat treatment is performed at a treatment lying in the range 400° C. to 600° C. for a period of one to several hours. This produces a refractory cement constituted essentially of SiO₂ and Al₂O₃ phases, together with NaAlSiO₄ when the liquid used for the cement paste is a solution of a sodium compound, such as sodium silicate.

The quantity of cement paste that is applied is selected to ensure that after heat treatment the refractory cement layer has the desired thickness.

The following step (206) consists in applying a slip onto the refractory cement layer, which slip is made up of glass frit in suspension in a liquid. The liquid is advantageously water, but it is nevertheless possible to use other liquids, e.g. a solution of ethylcellulose at 10% in terpineol. The glass frit is obtained by grinding glass of composition that is selected to produce a glaze having the desired properties, and in particular:

a glass transition temperature that is preferably lower than 750° C., e.g. lying in the range 600° C. to 650° C., the glass transition temperature being the temperature above which self-healing of the glaze can be obtained by softening of the glass that constitutes it;

a glazing temperature that is preferably lower than 1100° C., where the glazing temperature is the temperature to which the glass frit needs to be raised in order to achieve viscosity that is sufficiently low to enable it to spread with substantially uniform thickness, a glazing temperature of 1100° C. or higher being capable of affecting the mechanical properties of the fibers of the fiber reinforcement of the CMC substrate;

a coefficient of thermal expansion that is preferably close to that of the CMC substrate containing SiC, e.g. lying in the range 4×10⁻⁶K⁻¹ to 5×10⁻⁶K⁻¹; and

good chemical durability, in particular good resistance to moisture.

The composition of the glass frit, which is likewise the composition of the glass of the glaze that is subsequently obtained, may for example be as follows (in molar percentages), i.e. a composition that is essentially that of an alumino-borosilicate glass:

55% to 65% SiO₂

10% to 25% B₂O₃

7% to 15% Al₂O₃

1% to 12% of at least one alkali metal oxide

1% to 20% of at least one oxide selected from ZrO₂, TiO₂, V₂O₅, ZnO, CaO, MgO, and BaO.

A coloring agent is optionally added to give a desired color to the glaze. Various known coloring agents may be used, e.g. “cobalt blue”, “cobalt black”, or copper oxide CuO (green color).

It is possible to use a commercially available glass or to make a glass by mixing and melting its ingredients in the desired proportions.

The glass is ground in order to have a glass frit with a grain size of less than 100 μm, and preferably less than 40 μm.

The slip is applied by any known conventional means, e.g. using a spatula.

After drying (step 208) in order to eliminate the liquid, the temperature is raised progressively in order to cause the glass to soften and spread (glaze), with the temperature being maintained at the glazing temperature of the glass (step 210). The glazing temperature is a function of the composition of the glass, which glass is selected to have a glazing temperature that is preferably less than 1100° C., e.g. that lies in the range 1000° C. to 1100° C.

Cooling is then performed (step 212), preferably slowly, in order to freeze the glaze with as little residual stress as possible. The quantity of glass frit that is deposited may be selected so as to end up with the desired thickness for the glaze. This produces a coating having a smooth surface of shiny appearance that is possibly colored. For CMC parts that are for use in turbine engines, such a coating provides good aerodynamic properties, while making it easy to detect faults, e.g. resulting from impacts, merely by visual inspection. In addition, the coloring may be used to confer particular properties, in particular an attenuated infrared signature.

Examples of making coatings of the invention are described below. In all of the examples, the substrate is made of CMC of the SiC/SiC type comprising reinforcement made of SiC fiber yarns woven by multilayer weaving together with an SIC matrix obtained by CVI.

### Example 1

A refractory cement paste was prepared by mixing powder formed by a mixture of SiO₂ and Al₂O₃, with a SiO₂/Al₂O₃ molar ratio equal to about 1/8, with a liquid constituted by a solution of sodium silicate with an SiO₂/Na₂O molar ratio equal to about 3/2. The liquid/powder proportion by weight was about 1.5.

A spatula was used to apply the cement paste onto a surface of the substrate, with its thickness being selected to obtain a final refractory cement layer having a minimum thickness of about 100 μm.

The assembly comprising the substrate and the cement paste was left in open air at ambient temperature for about 24 hours (h) in order to allow the cement to set.

Heat treatment was then performed at about 600° C. under air for a period of about 2 h.

A glass frit was obtained by grinding a glass having the following composition, in molar percentages, and ignoring impurities, if any:

about 56% SiO₂

about 21% B₂O₃

about 11% Al₂O₃

about 5% CaO

about 5% BaO and

about 2% K₂O

Grinding was performed so as obtain a grain size of less than about 40 μm.

A slip formed by the glass frit in suspension in distilled water was spread with a spatula over the coating layer of refractory cement, the quantity of glass frit that was applied being selected to obtain a glaze having a final thickness of about 300 μm.

After drying, the temperature was raised progressively up to about 1000° C. and was held at that temperature for about 15 minutes (min) in order to ensure substantially uniform spreading of the glass.

After cooling slowly in air, a coating was obtained that presented an outside surface that was smooth, shiny, and free of undulations.

### Example 2

The procedure was as in Example 1, but with a glass frit having the following composition in molar percentages, ignoring impurities, if any:

about 62% SiO₂

about 12% B₂O₃

about 4% Al₂O₃

about 6% ZnO

about 7% CaO

about 5% NaKO

about 4% ZrO₂

In addition, for the heat treatment for glazing the refractory cement layer with the glaze, the substrate carrying the refractory cement and the glass frit was inserted directly into an oven at 1000° C. and maintained at this temperature for about 15 min, followed by controlled slow cooling at about −2 kelvins per minute (K·min⁻¹).

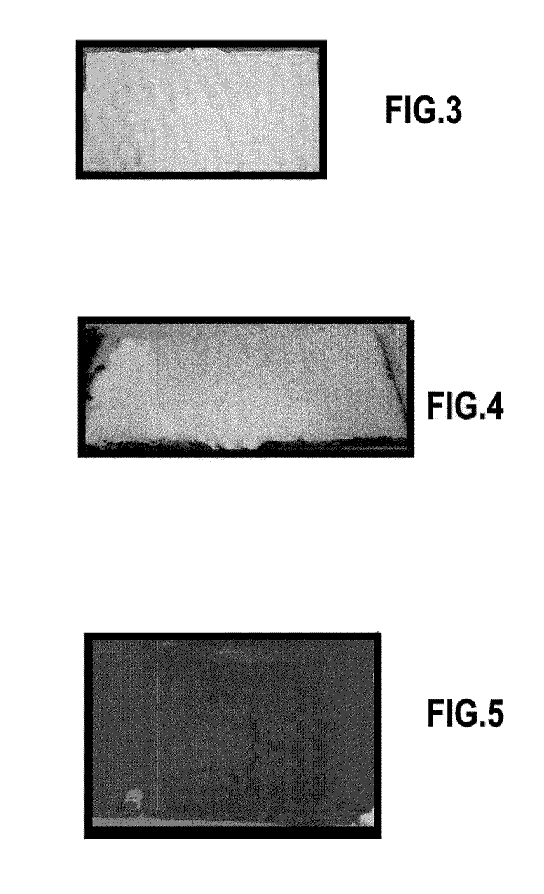

FIG. 3 shows the surface of the refractory cement layer prior to application of the glaze, and FIG. 4 shows the surface of the glaze. It can be seen that surface undulations are still visible on the surface of the refractory cement layer but that they practically disappear after application of the glaze. Observation using a scanning electron microscope shows a mean amplitude of the undulations of about 16 μm, as compared with a value of 355 μm as measured on the starting substrate.

The chemical durability of the glass was tested by the Soxhelt method that serves to simulate leeching of the glass by using water at a temperature of 100° C. in a closed circuit in application of the ISO 16797: 2004 standard. After 800 h, the measured loss of mass was only 0.8% in relative value.

### Example 3

The procedure was as in Example 2, but with cobalt blue added to the slip at a proportion of 5% by weight relative to the weight of the slip constituted by the glass frit and water.

A blue color coating was obtained having a smooth outside surface of glazed appearance.

### Example 4

The procedure was as in Example 3, but cobalt blue was replaced with cobalt black.

FIG. 5 shows the black color coating that was obtained having a smooth outside surface of glazed appearance.

1-12. (canceled)

13. A method of forming a coating having a smooth outside surface of glazed appearance on a substrate of ceramic matrix composite material containing silicon carbide, the method including:
depositing a refractory cement paste on a surface of the substrate, the paste being formed by a powder mainly constituted by silica and alumina and mixed with a liquid, the cement paste filling in the hollow portions in relief of the surface in order to reduce its irregularities and covering the entire surface of the substrate;
performing heat treatment to harden the cement after it has set so as to obtain a first coating layer of refractory cement;
depositing a slip on the first coating layer, the slip being formed of a glass frit in suspension in a liquid, the glass frit being mainly constituted by a powder of silica, boron oxide, alumina, and at least one alkali metal oxide; and
performing heat treatment for glazing by softening and spreading the glass in order to obtain a second coating layer forming a glaze covering the first coating layer;
wherein the composition of the glass frit is selected to form a glass having a glazing temperature lower than 1100° C. and a glass transition temperature lower than 750° C.

14. A method according to claim 13, wherein a coloring agent is added to the slip.

15. A method according to claim 13, wherein the liquid of the cement paste is selected from the group consisting of: a solution of sodium silicate; a solution of phosphoric acid; and a solution of aluminum monophosphate (Al(H₂PO₄)₃).

16. A method according to claim 13, wherein a first coating layer of refractory cement is formed having a minimum thickness of not less than 60 μm.

17. A method according to claim 13, wherein the glass frit is constituted by powder having a grain size of less than 40 μm.

18. A method according to claim 13, wherein the composition of the glass frit, in molar percentages, is as follows:
55% to 65% SiO₂;
10% to 25% B₂O₃;
7% to 15% Al₂O₃;
1% to 12% of at least one alkali metal oxide; and
1% to 20% of at least one oxide selected from the group consisting of: ZrO₂, TiO₂, V₂O₅, ZnO, CaO, MgO, and BaO.

19. A method according to claim 13, wherein the second coating layer forming a glaze has thickness of not less than 100 μm.

20. A part comprising a substrate of ceramic matrix composite material containing silicon carbide that is provided on a surface with a coating having a smooth outside surface of glazed appearance, wherein the coating is formed:
of a first coating layer in contact with the surface of the substrate, the first coating layer being made of a refractory cement essentially constituted of silica and of alumina and filling in the hollow portions in relief of the surface in order to reduce its irregularity; and
a second coating layer forming a glaze of glass constituted mainly of oxides of silicon, of boron, of aluminum, and of at least one alkali metal, the glass having a melting temperature lower than 1100° C. and a glass transition temperature lower than 750° C.

21. A part according to claim 20, wherein the glaze also contains a coloring agent.

22. A part according to claim 20, wherein the first coating layer of refractory cement has a minimum thickness of not less than 60 μm.

23. A part according to claim 20, wherein the second coating layer forming a glaze has a thickness of not less than 100 μm.

24. A part according to claim 20, wherein the composition of the glass of the glaze in molar percentages is as follows:
55% to 65% SiO₂;
10% to 25% B₂O₃;
7% to 15% Al₂O₃;
1% to 12% of at least one alkali metal oxide; and
1% to 20% of at least one oxide selected from the group consisting of: ZrO₂, TiO₂, V₂O₅, ZnO, CaO, MgO, and BaO.
